(19) United States
(12) Patent Application Publication
(10) Pub. No.: US 2017/0048897 A1
(43) Pub. Date: Feb. 16, 2017

(54) Methods and Apparatuses for Notifying or Updating ProSe Temporary Identifier

(71) Applicant: ZTE Corporation, Shenzhen (CN)

(72) Inventors: Shuang LIANG, Shenzhen (CN); Jinguo ZHU, Shenzhen (CN)

(21) Appl. No.: 15/303,161

(22) PCT Filed: Oct. 23, 2014
(86) PCT No.: PCT/CN2014/089230

§ 371 Date: Oct. 10, 2016

(30) Foreign Application Priority Data
Apr. 11, 2014 (CN) 201410145491.9

(51) Int. Cl. H04W 76/02; H04L 29/06

(52) U.S. Cl. CPC H04W 76/02; H04L 29/06; H04W 88/02

(57) ABSTRACT

Methods and apparatuses for notifying or updating a Proximity-based Services (ProSe) temporary identifier are provided. The method for notifying a ProSe temporary identifier includes: determining that a ProSe temporary identifier acquired by an announcing UE is revoked; and notifying the announcing UE that the ProSe temporary identifier acquired by the announcing UE is revoked. The technical solution solves the problem that an announcing UE cannot learn of the fact that a ProSe temporary identifier is revoked, and thus avoids a UE discovery fault.

### TECHNICAL FIELD

The present disclosure relates to the field of communications, and in particular to methods and apparatuses for notifying or updating a Proximity-based Services (ProSe) temporary identifier.

### BACKGROUND

To remain a 3^{rd} generation mobile communication system competitive in the field of communications, mobile communication services which are high in rate, low in delay and more personalized are provided for users. Meanwhile, the operation cost of an operator is reduced, and a 3^{rd} Generation Partnership Project (3GPP) standard working group is devoting itself to research on an Evolved Packet System (EPS).

When two UEs communicate by means of an EPS network, the two UEs need to respectively establish bearers with the EPS. However, in view of rapid development of smart terminals and various mobile internet services, many services are intended to be capable of discovering friends in proximity for communication, and therefore ProSe is created. UEs supporting this function can communicate by means of specific resources authorized by a network. When such a technology is adopted, a communication path may not pass a core network. This communication mode reduces roundabout data routing and reduces network data loads as well.

After the ProSe is introduced, some network elements and interfaces are added to the network so as to support this function. FIG. 1 is a structural diagram of an EPS according to the related art. As shown in FIG. 1, the EPS may include, but is not limited to, the following network elements and interfaces:

a UE A/UE B (UE A/UE B) supporting a ProSe function, which can discover each other and communicate with each other after being authorized by a network side;

a ProSe function, also called as a proximity server, provided to support ProSe, wherein the ProSe function is mainly used for authorizing a UE to discover another UE and authorizing the UE to be discovered by another UE, and matching the UEs, in some solutions, the network element is further responsible for an agreement between the UEs for mutual discovery;

an Evolved Universal Terrestrial Radio Access Network (EUTRAN), providing bottom layer access and necessary discovery and communication resources for a ProSe UE;

an Evolved Packet Core Network (EPC), including a Mobility Management Entity (MME) and a Serving Gateway (SGW)/Packet Data Network Gateway (PGW), these network elements providing bottom layer access for access of a ProSe function to a UE;

a Home Subscriber Server (HSS), which contains all functions of a Home Location Register (HLR), is a permanent storage place for subscriber data and is located in a subscriber home network, wherein after the ProSe is introduced, the network element needs to store ProSe-related subscriber data;

a Secure User Plane Location Platform (SLP), configured to assist in discovery of UEs in proximity to each other; and

a ProSe application server, configured to map an identifier of a user application layer and a user identifier (ID) of a user in a 3GPP network.

An operator allocates a unique application ID for an application on a UE. For example, the identifier includes Public Land Mobile Network (PLMN) information and application ID information, the PLMN information includes a country code and a network number, and the application ID information may uniquely identify one application and may also uniquely identify a class of applications such as hotels and restaurants. In case of coverage, if the UE needs to use frequency band resources of the operator, the UE needs to be authorized by the operator, and the operator can perform control and charge. In this case, the UE is generally not allowed to directly announce its own application ID, but needs to acquire a temporary identifier code uniquely corresponding to the application ID from the proximity server, and then announces the temporary identifier code.

ProSe direct discovery between two UEs includes two processes: UE A announcing and UE B monitoring. If a UE B has known a monitored code A, the UE B discovers that a UE A is in proximity. If the UE B does not know the monitored code A, a matching process is initiated to a network, so that an application ID of the UE A corresponding to the code A is acquired, thus discovering that the UE A is in proximity. The descriptions of these three processes are shown in FIG. 2, FIG. 3 and FIG. 4.

FIG. 2 is a diagram of an announce request process according to the related art. As shown in FIG. 2, the process includes the steps (Step S202 to Step S216) as follows.

Step S202: A UE A acquires an application ID from an operator, wherein the application ID is allowed to be used by the UE A only.

Step S204: If the UE A expects to announce itself using radio resources of the operator so as to enable other people to discover the UE A, the UE A establishes connection with a network, and sends an announce request message to a proximity server, wherein the request includes an application ID to be announced, a UE identifier and an announcing indicator. The UE A generates an identifier of the proximity server according to a PLMN identifier of the PLMN to which the UE A corresponds, and acquires an Internet Protocol (IP) address of a home proximity server by Domain Name Server (DNS) search. The UE identifier is an International Mobile Subscriber Identification (IMSI) or a Mobile Subscriber Integrated Service Digital Network/Public Switched Telephone Network (ISDN/PSTN).

Step S206: After receiving the announce request, the proximity server sends, if there is no user context, a subscription request carrying a user ID to the home server.

Step S208: The home server returns subscription information of the UE in a subscription response.

Step S210: If the home proximity server judges, according to the subscription information, that the UE is allowed to execute Device to Device (D2D) services and the user indeed subscribes to the application corresponding to the sent application ID, a user context is created, a temporary broadcast identifier code A and a corresponding validity period are allocated for the application ID sent by the user. For the scenario that the UE A probably roams to a visited network, the home proximity server also needs to notify a visitor location proximity server of the temporary identifier code A.

Step S212: The proximity server returns the allocated temporary broadcast identifier code A and the corresponding validity period to the UE A.

Step S214: The UE A may acquire radio resources in two modes. In the first mode, the UE A is configured with radio resources corresponding to each PLMN allowing D2D announcing. Thus, when the UE is not under coverage or a base station indicates adoption of this mode, D2D radio resources matching a currently registered PLMN can be discovered. In the second mode, the base station allocates available D2D radio resources for the UE A.

Step S216: The UE A announces the acquired code A on the acquired radio resources. To improve the efficiency, the UE A sets a timer, and performs regular announcing within the validity period indicated by Step S210.

When the validity period expires, the broadcast identifier code A becomes invalid, and the UE A has to re-initiate an announce request process to acquire a broadcast identifier code A and a validity period again.

FIG. 3 is a diagram of a monitor request process according to the related art. As shown in FIG. 3, the process includes the steps (Step S302 to Step S316) as follows.

Step S302: A UE B acquires an application ID of a UE A from an operator or a third party.

Step S304: If the UE B expects to discover the UE A, the UE B establishes a connection with a network, and sends a monitor request to a proximity server, wherein the request carries an application ID of the UE A that the UE B expects to discover, and a UE identifier of the UE B. The UE B generates an identifier of the proximity server according to a PLMN identifier of the PLMN to which the UE B corresponds, and acquires an IP address of a home proximity server by DNS search. The UE identifier is IMSI or MSISDN.

Step S306: After receiving the discovery request, the proximity server sends, if there is no user context, a subscription request carrying a user ID to the home server.

Step S308: The home server returns subscription information of the UE in a subscription response.

Step S310: If the home proximity server judges, according to the subscription information, that the UE is allowed to execute D2D services, a user context is created.

Step S312: The home proximity server finds a corresponding temporary broadcast identifier code A according to the application ID of the UE A, and sends a validity period together with the identifier code A to the UE B. If the UE A and the UE B do not belong to the same operator, the home proximity server of the UE B finds a home proximity server of the UE A according to the application ID of the UE A, and queries from the home proximity server of UE A to acquire the code A.

Step S314: The UE B acquires radio resources. The UE B is configured with radio resources corresponding to each PLMN allowing D2D monitoring. The UE may monitor all of these radio resources within the validity period indicated by Step 306.

Step S316: If the UE B discovers the code A through monitoring, the UE B successfully discovers that the UE A is in proximity.

When the validity period expires, the code A becomes invalid, and the UE B has to re-initiate a monitor request process to re-acquire a new code A and a validity period.

If UE A corresponds to a certain type of application in Step S304, a filter may be returned in Step S312, and then if the monitored code in Step S316 matches the mask, for example, first few bits of the code completely match the mask, UE B needs to initiate a matching process to acquire an application ID corresponding to the code.

FIG. 4 is a diagram of a match request process according to the related art. As shown in FIG. 4, the process includes the steps (Step S402 to Step S412) as follows.

Step S402: A UE B discovers a code A through monitoring, wherein the code A matches a mask, but the UE B does not know the code A.

Step S404: The UE B establishes connection with a network, and sends a match request to a proximity server, wherein the request carries the discovered code A and a UE identifier of the UE B. The UE B generates an identifier of the proximity server according to a PLMN identifier of the PLMN to which the UE B corresponds, and acquires an IP address of a home proximity server by DNS search. The UE identifier is IMSI or MSISDN.

Step S406: After receiving the discovery request, the proximity server sends, if there is no user context, a subscription request carrying a user ID to the home server.

Step S408: The home server returns subscription information of the UE in a subscription response.

Step S410: The home proximity server judges, according to the subscription information, that the UE is allowed to execute D2D services. The home proximity server acquires an application ID of a UE A according to the code A. If the UE A and the UE B do not belong to the same operator, the home proximity server of the UE B finds the home proximity server of the UE A according to the code A of the UE A, and queries from the home proximity server of UE A to acquire an application layer identifier.

Step S412: The home proximity server sets a validity period of the code A, and then returns the application ID of the UE A and the validity period to the UE B, such that the UE B successfully discovers that the UE A is in proximity. Within the validity period, the code A and the application ID of the UE A match each other.

An HSS may change subscription data, and a home proximity server may decide anytime whether or not a code is valid. When an operator decides not to allow a UE to use a ProSe service, a mechanism for instantaneously notifying a related UE to end a discovery service does not exist yet currently.

### SUMMARY

The embodiments of the present disclosure provide methods and apparatuses for notifying or updating a ProSe temporary identifier, which are intended to at least solve the problem of UE discovery fault caused by the fact that an announcing UE or a monitoring UE cannot learn of the fact that a ProSe temporary identifier is revoked in the related art.

According to one embodiment of the present disclosure, a method for notifying a ProSe temporary identifier is provided, which may include the steps as follows. It is determined that a first ProSe temporary identifier acquired by an announcing UE is revoked. The announcing UE is notified that the first ProSe temporary identifier is revoked.

The method may further include the step as follows. The announcing UE is notified of a new second ProSe temporary identifier of the announcing UE.

The method may further include the step as follows. A ProSe function, to which a monitoring UE having acquired the first ProSe temporary identifier corresponds, is notified that the first ProSe temporary identifier is revoked and/or a mask of the first ProSe temporary identifier is revoked, and/or is notified of a second ProSe temporary identifier and/or a mask of the second ProSe temporary identifier.

The method may further include the step as follows. A visited ProSe function of the announcing UE is notified of a second ProSe temporary identifier and/or the visited ProSe function is notified that the first ProSe temporary identifier is revoked.

The method may further include the step as follows. A reason for revoking the first ProSe temporary identifier is notified.

The step that it is determined that the first ProSe temporary identifier acquired by the announcing UE is revoked may include at least one of the steps as follows. Upon receiving from an HSS a message used for notifying that the first ProSe temporary identifier is revoked, it is determined that the first Pro Se temporary identifier is revoked. Upon receiving from the HSS a message used for notifying ProSe information of the announcing UE, it is determined, according to the ProSe information, that the first ProSe temporary identifier is revoked. It is determined, according to a function change of a ProSe function, that the first ProSe temporary identifier is revoked.

The ProSe information may include at least one of: ProSe subscription change information and register state change information.

The function change of the ProSe function may include at least one of: ProSe function management and maintenance, and application layer notice indicating that a UE identifier of the announcing UE is revoked.

According to another embodiment of the present disclosure, a method for notifying a ProSe temporary identifier is provided, which may include the steps as follows. It is determined that ProSe information of an announcing UE changes. A ProSe function to which the announcing UE corresponds is notified that a first ProSe temporary identifier acquired by the announcing UE is revoked, and/or the ProSe function is notified of the ProSe information.

The method may further include the steps as follows. An MME where the announcing UE resides is notified of the ProSe information. The MME judges, according to the ProSe information, whether or not to reclaim announcing resources allocated for the announcing UE.

Before the ProSe function is notified that the first ProSe temporary identifier is revoked, the method may further include the step as follows. It is determined, according to the ProSe information, that the first ProSe temporary identifier is revoked.

The ProSe information may include at least one of: ProSe subscription change information and register state change information.

According to another embodiment of the present disclosure, a method for notifying a ProSe temporary identifier is also provided, which may include the steps as follows. It is acquired that a first ProSe temporary identifier acquired by an announcing UE is revoked. A monitoring UE which has acquired the first ProSe temporary identifier is notified that the first ProSe temporary identifier is revoked and/or a mask of the first ProSe temporary identifier is revoked.

The method may further include the steps as follows. A new second ProSe temporary identifier of the announcing UE is acquired. The monitoring UE which has acquired the first ProSe temporary identifier is notified of a second ProSe temporary identifier and/or a mask of the second ProSe temporary identifier.

The method may further include the steps as follows. A reason for revoking the first ProSe temporary identifier is acquired. The monitoring UE is notified of the reason.

According to another embodiment of the present disclosure, a method for updating a ProSe temporary identifier is provided, which may include the steps as follows. A new second ProSe temporary identifier of an announcing UE is acquired and/or it is acquired that a first ProSe temporary identifier acquired by the announcing UE is revoked.

When it is acquired that the first ProSe temporary identifier is revoked, the method may further include the steps as follows. A monitor request used for re-acquiring a ProSe temporary identifier is initiated. The second ProSe temporary identifier returned in response to the monitor request is received.

The method may further include the steps as follows. A mask of the second ProSe temporary identifier is acquired and/or it is acquired that a mask of the first ProSe temporary identifier is revoked.

When it is acquired that the first ProSe temporary identifier is revoked, the method may further include the steps as follows. A discovery request used for re-acquiring a ProSe temporary identifier is initiated. The second ProSe temporary identifier returned in response to the discovery request is received.

The method may further include the step as follows. A reason for revoking the first ProSe temporary identifier is acquired.

According to another embodiment of the present disclosure, an apparatus for notifying a ProSe temporary identifier is provided, which may include: a determination component, configured to determine that a first ProSe temporary identifier acquired by an announcing UE is revoked; and a first notification component, configured to notify the announcing UE that the first ProSe temporary identifier is revoked.

The apparatus may further include: the first notification component, further configured to notify the announcing UE of a new second ProSe temporary identifier of the announcing UE.

The apparatus may further include: a second notification component, configured to notify a ProSe function, to which a monitoring UE having acquired the first ProSe temporary identifier corresponds, that the first ProSe temporary identifier is revoked and/or a mask of the first ProSe temporary identifier is revoked, and/or notify the ProSe function of a second ProSe temporary identifier and/or a mask of the second ProSe temporary identifier.

The apparatus may further include: a third notification component, configured to notify a visited ProSe function of the announcing UE of a second ProSe temporary identifier and/or notify the visited ProSe function that the first ProSe temporary identifier is revoked.

The determination component may include at least one of: a first determination unit, configured to determine, upon receiving from an HS S a message used for notifying that the first ProSe temporary identifier is revoked, that the first ProSe temporary identifier is revoked; a second determination unit, configured to determine, upon receiving from the HSS a message used for notifying ProSe information of the announcing UE, that the first ProSe temporary identifier is revoked according to the ProSe information; and a third determination unit, configured to determine, according to a function change of a ProSe function, that the first ProSe temporary identifier is revoked.

According to another embodiment of the present disclosure, an apparatus for notifying a ProSe temporary identifier is provided, which may include: a first determination component, configured to determine that ProSe information of an announcing UE changes; and a notification component, configured to notify a ProSe function, to which the announcing UE corresponds, that a first ProSe temporary identifier acquired by the announcing UE is revoked, and/or notify the ProSe function of the ProSe information.

The apparatus may further include: a second determination component, configured to determine, before the ProSe function is notified that the first ProSe temporary identifier is revoked, that the first ProSe temporary identifier is revoked according to the ProSe information.

According to another embodiment of the present disclosure, an apparatus for notifying a ProSe temporary identifier is provided, which may include: an acquisition component, configured to acquire that a first ProSe temporary identifier acquired by an announcing UE is revoked; and a notification component, configured to notify a monitoring UE, which has acquired the first ProSe temporary identifier, that the first ProSe temporary identifier is revoked and/or a mask of the first ProSe temporary identifier is revoked.

The acquisition component may be further configured to acquire a new second ProSe temporary identifier of the announcing UE. The notification component may be further configured to notify the monitoring UE, which has acquired the first ProSe temporary identifier, of a second ProSe temporary identifier and/or a mask of the second ProSe temporary identifier.

According to another embodiment of the present disclosure, an apparatus for updating a ProSe temporary identifier is also provided, which may include: an acquisition component, configured to acquire a message indicating that a first ProSe temporary identifier acquired by an announcing UE is revoked and/or a message of a new second ProSe temporary identifier of the announcing UE.

The apparatus may further include a first updating component. The first updating component may include: a first request unit, configured to initiate, when the message that the first ProSe temporary identifier is revoked is acquired, a monitor request used for re-acquiring a ProSe temporary identifier; and a first receiving unit, configured to receive the second ProSe temporary identifier returned in response to the monitor request.

The apparatus may further include a second updating component. The second updating component may include: a second request unit, configured to initiate, when the message that the first ProSe temporary identifier is revoked is acquired, a discovery request used for re-acquiring a ProSe temporary identifier; and a second receiving unit, configured to receive the second ProSe temporary identifier returned in response to the discovery request.

By means of the technical solution of the embodiments of the present disclosure, it is determined that a ProSe temporary identifier acquired by an announcing UE is revoked, and the announcing UE is notified that the ProSe temporary identifier is revoked, thus solving the problem that an announcing UE cannot learn of the fact that a ProSe temporary identifier is revoked, and avoiding a UE discovery fault.

### BRIEF DESCRIPTION OF THE DRAWINGS

The drawings illustrated herein are intended to provide further understanding of the present disclosure, and form a part of the present disclosure. The schematic embodiments and illustrations of the present disclosure are intended to explain the present disclosure, and do not form improper limits to the present disclosure. In the drawings:

FIG. 1 is a structural diagram of an EPS according to the related art;

FIG. 2 is a diagram of an announce request process according to the related art;

FIG. 3 is a diagram of a monitor request process according to the related art;

FIG. 4 is a diagram of a match request process according to the related art;

FIG. 5 is a flowchart 1 of a method for notifying a ProSe temporary identifier according to an embodiment of the present disclosure;

FIG. 6 is a structural diagram 1 of an apparatus for notifying a ProSe temporary identifier according to an embodiment of the present disclosure;

FIG. 7 is a flowchart 2 of a method for notifying a ProSe temporary identifier according to an embodiment of the present disclosure;

FIG. 8 is a structural diagram 2 of an apparatus for notifying a ProSe temporary identifier according to an embodiment of the present disclosure;

FIG. 9 is a flowchart 3 of a method for notifying a ProSe temporary identifier according to an embodiment of the present disclosure;

FIG. 10 is a structural diagram 3 of an apparatus for notifying a ProSe temporary identifier according to an embodiment of the present disclosure;

FIG. 11 is a flowchart of a method for updating a ProSe temporary identifier according to an embodiment of the present disclosure;

FIG. 12 is a structural diagram of an apparatus for updating a ProSe temporary identifier according to an embodiment of the present disclosure;

FIG. 13 is a flowchart of a method for updating a ProSe temporary identifier according to an exemplary implementation 1 of an embodiment of the present disclosure;

FIG. 14 is a flowchart of a method for updating a ProSe temporary identifier according to an exemplary implementation 2 of an embodiment of the present disclosure;

FIG. 15 is a flowchart of a method for updating a ProSe temporary identifier according to an exemplary implementation 3 of an embodiment of the present disclosure; and

FIG. 16 is a flowchart of showing a scenario where an HSS initiates subscription data modification according to an embodiment of the present disclosure.

### DETAILED DESCRIPTION OF THE EMBODIMENTS

The present disclosure will be illustrated below with reference to the drawings and in conjunction with the embodiments in detail. It is important to note that the embodiments of the present disclosure and the features in the embodiments can be combined under the condition of no conflicts.

In the following embodiments, UEs may be mobile terminals (for example, mobile phones and tablet computers), or may be terminals of other types. Operating systems running on the UEs may be systems of various types including, but not limited to, an android system which is widely used at present, or a Windows operating system or an iOS. Devices may be servers and various gateways, or may be devices of other types.

Each UE or device may include a storage medium. A program unit stored in the storage medium may be configured to execute methods described in the following embodiments. Each UE or device may further include a processor, which may be configured to execute the program unit. It is conceived that the methods or apparatus described below may be implemented by means of the program unit.

According to an embodiment of the present disclosure, a method for notifying a ProSe temporary identifier is provided.

FIG. 5 is a flowchart 1 of a method for notifying a ProSe temporary identifier according to an embodiment of the present disclosure. As shown in FIG. 5, the method includes Step S502 to Step S504.

Step S502: It is determined that a ProSe temporary identifier acquired by an announcing UE is revoked.

Step S504: The announcing UE is notified that the acquired ProSe temporary identifier is revoked.

By means of the technical solution embodiment of the present disclosure, the problem that an announcing UE cannot learn of the fact that a ProSe temporary identifier is revoked is solved, and a UE discovery fault is avoided.

In one implementation of the embodiment of the present disclosure, the method may further include the step as follows. The announcing UE is notified of a new ProSe temporary identifier.

In one implementation of the embodiment of the present disclosure, the method may further include the step as follows. A ProSe function, to which a monitoring UE having acquired the ProSe temporary identifier of the announcing UE corresponds, is notified that the ProSe temporary identifier acquired previously by the announcing UE is revoked and/or a mask and/or filter of the ProSe temporary identifier is revoked, and/or the ProSe function is notified of the new ProSe temporary identifier and/or a mask and/or filter of the new ProSe temporary identifier.

In the embodiment of the present disclosure, the ProSe temporary identifier may be sent; alternatively, a mask or a filter may be sent, so that the monitoring UE can be matched to one or more temporary identifiers.

By means of the above implementations, the ProSe function, to which the monitoring UE corresponds, may be notified that the ProSe temporary identifier acquired by the announcing UE is revoked or may be notified of the new ProSe temporary identifier. Certainly, the ProSe function may be notified of the corresponding mask and/or filter, thus avoiding that the monitoring UE cannot acquire whether the ProSe temporary identifier acquired by the announcing UE is revoked. Furthermore, the ProSe function, to which the monitoring UE corresponds, may notify the monitoring UE of the above information.

In one implementation of the embodiment of the present disclosure, the method may further include the step as follows. A visited ProSe function of the announcing UE is notified of the new ProSe temporary identifier of the announcing UE and/or the visited ProSe function is notified that the ProSe temporary identifier acquired previously by the announcing UE is revoked.

After receiving the above notification, the visited ProSe function of the announcing UE may reclaim resources assigned by an announcing apparatus.

It is important to note that the sequence of executing the above two implementations and Step S504 is not restrained. For example, the announcing UE may be notified first, and then the ProSe function to which the monitoring UE corresponds and the visited ProSe function of the announcing UE are notified. Certainly, the sequence of notifying the ProSe function to which the monitoring UE corresponds and the visited ProSe function of the announcing UE is not restrained either. As another example, the ProSe function to which the monitoring UE corresponds and the visited ProSe function of the announcing UE may be notified first, and then the announcing UE is notified.

If the ProSe function to which the monitoring UE corresponds is notified of a new ProSe temporary identifier of the announcing UE, the announcing UE may be notified first. After the announcing UE acquires the new ProSe temporary identifier, the ProSe function to which the monitoring UE corresponds is notified of the new ProSe temporary identifier. Certainly, it is also possible that the announcing UE is notified that the acquired ProSe temporary identifier is revoked and then the announcing UE is notified of a new ProSe temporary identifier.

The embodiment of the present disclosure does not limit the sequence of the notification processes. The sequence may be any execution sequence which is regarded, by those skilled in the art, to be capable of completing the notification processes.

In one implementation of the embodiment of the present disclosure, the step that it is determined that the ProSe temporary identifier acquired by the announcing UE is revoked is implemented by at least one of the manners as follows.

(1) Upon receiving from an HSS a message used for notifying that the acquired ProSe temporary identifier is revoked, it is determined that the acquired ProSe temporary identifier is revoked.

In manner (1), the HSS may decide whether or not the ProSe temporary identifier acquired by the announcing UE is revoked, and send a decision result. That is, upon receiving a notification message from the HSS, it may be determined, according to the decision result made by the HSS, whether or not the ProSe temporary identifier acquired by the announcing UE is revoked.

(2) Upon receiving from the HSS a message used for notifying ProSe information of the announcing UE, it is determined, according to the ProSe information, that the ProSe temporary identifier acquired by the announcing UE is revoked.

In manner (2), the HSS may notify of the ProSe information of the announcing UE, and in the case where the HSS does not make a decision, the complexity of the HSS can be reduced. Since the ProSe information of the announcing UE is received, it may be determined, according to the ProSe information, whether or not the ProSe temporary identifier acquired by the announcing UE is revoked.

The ProSe information may include at least one of: ProSe subscription change information and register state change information. The ProSe subscription change information may include: change of the announcing UE from ProSe supportive UE to ProSe non-supportive UE, or from discovery allowing UE to discovery disallowing UE. The register state change information may include: movement of the announcing UE to another PLMN, or receiving of a purge process initiated by an MME of a PLMN to which the announcing UE is currently registered.

(3) It is determined, according to a function change of a ProSe function, that the ProSe temporary identifier acquired by the announcing UE is revoked.

The function change of the ProSe function may include at least one of: ProSe function management and maintenance, and application layer notice indicating that a UE identifier of the announcing UE is revoked.

In one implementation of the embodiment of the present disclosure, the announcing UE may also be notified of a reason for revoking the acquired ProSe temporary identifier. The reason may include, but are not limited to, ProSe function management and maintenance, application layer notice indicating that a UE identifier of the announcing UE is revoked, ProSe subscription change information and register state change information.

According to an embodiment of the present disclosure, in correspondence to the above method, an apparatus for notifying a ProSe temporary identifier is provided. It is conceivable that the apparatus may be implemented by means of a program unit, and the program unit may be located in a memory of a device and executed by a processor of the device.

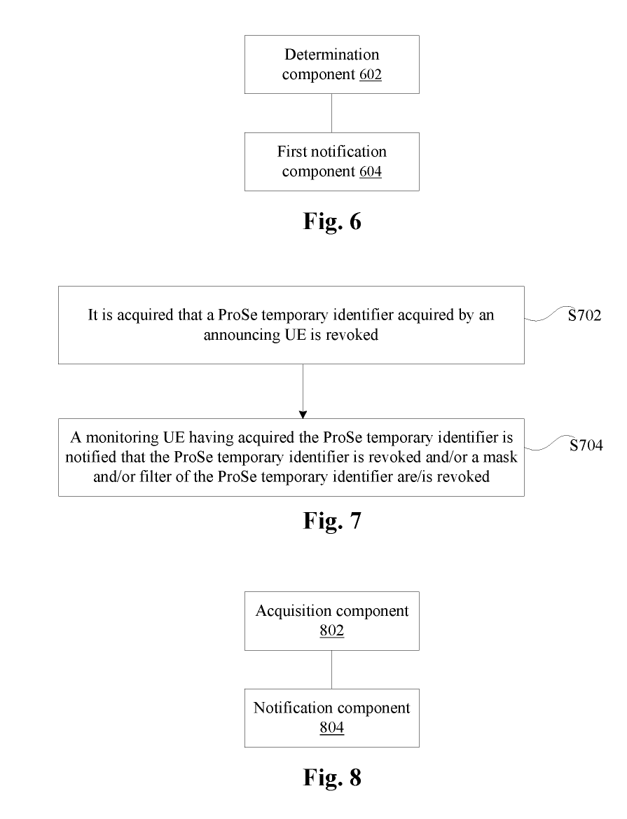

FIG. 6 is a structural diagram 1 of an apparatus for notifying a ProSe temporary identifier according to an embodiment of the present disclosure. As shown in FIG. 6, the apparatus includes: a determination component 602 and a first notification component 604, wherein the determination component 602 is configured to determine that a ProSe temporary identifier acquired by an announcing UE is revoked; and the first notification component 604 is configured to notify the announcing UE that the acquired ProSe temporary identifier is revoked and/or a mask and/or filter of the ProSe temporary identifier are/is revoked.

By means of the technical solution of the embodiment of the present disclosure, the problem that an announcing UE cannot learn of the fact that a ProSe temporary identifier is revoked is solved, and a UE discovery fault is avoided.

In one implementation of the embodiment of the present disclosure, the first notification component 604 may be further configured to notify the announcing UE of a new ProSe temporary identifier and/or a mask and filter of the new ProSe temporary identifier.

In one implementation of the embodiment of the present disclosure, the apparatus may further include: a second notification component, configured to notify a ProSe function, to which a monitoring UE having acquired the ProSe temporary identifier acquired by the announcing UE corresponds, that the ProSe temporary identifier is revoked, and/or notify the ProSe function, to which the monitoring UE corresponds, of the new ProSe temporary identifier of the announcing UE.

In one implementation of the embodiment of the present disclosure, the apparatus may further include: a third notification component, configured to notify a visited ProSe function of the announcing UE of the new ProSe temporary identifier of the announcing UE, and/or notify the visited ProSe function that the ProSe temporary identifier acquired by the announcing UE is revoked.

In correspondence to the above method of the embodiment of the present disclosure, the first notification component 604, the second notification component and the third notification component do not have a relation of subordination, and the execution sequence of the functions are not limited. Any sequences which can be conceived by those skilled in the art and can complete the notification processes are applicable.

In one implementation of the embodiment of the present disclosure, the determination component 602 may include at least one of:

(1) a first determination unit, configured to determine, upon receiving from an HSS a message used for notifying that the first ProSe temporary identifier is revoked, that the ProSe temporary identifier acquired by the announcing UE is revoked;

(2) a second determination unit, configured to determine, upon receiving from the HSS a message used for notifying ProSe information of the announcing UE, that the ProSe temporary identifier acquired by the announcing UE is revoked according to the ProSe information.

The ProSe information may include at least one of: ProSe subscription change information and register state change information. The ProSe subscription change information may include: change of the announcing UE from ProSe supportive UE to ProSe non-supportive UE, or from discovery allowing UE to discovery disallowing UE. The register state change information may include: movement of the announcing UE to another PLMN, or receiving of a purge process initiated by an MME of a PLMN to which the announcing UE is currently registered.

(3) a third determination unit, configured to determine, according to a function change of a ProSe function, that the ProSe temporary identifier acquired by the announcing UE is revoked.

The function change of the ProSe function may include at least one of: ProSe function management and maintenance, and application layer notice indicating that a UE identifier of the announcing UE is revoked.

In one implementation of the embodiment of the present disclosure, the announcing UE may also be notified of a reason for revoking the acquired ProSe temporary identifier. The reason may include, but are not limited to, ProSe function management and maintenance, application layer notice indicating that a UE identifier of the announcing UE is revoked, ProSe subscription change information and register state change information.

The apparatus in the embodiment of the present disclosure may be located in the ProSe function. The ProSe function may be an independent device which may include a processor and a storage medium, a program unit implementing the apparatus is stored in the storage medium, and the program unit is executed by the processor.

The above method and apparatus in the embodiment of the present disclosure may be executed by a ProSe function to which the announcing UE corresponds.

According to an embodiment of the present disclosure, a method for notifying a ProSe temporary identifier is also provided. The method may be completed by a ProSe function to which a monitoring UE corresponds.

FIG. 7 is a flowchart 2 of a method for notifying a ProSe temporary identifier according to an embodiment of the present disclosure. As shown in FIG. 7, the method includes Step S702 to Step S704.

Step S702: It is acquired that a ProSe temporary identifier acquired by an announcing UE is revoked.

Step S704: A monitoring UE having acquired the ProSe temporary identifier is notified that the ProSe temporary identifier is revoked and/or a mask and/or filter of the ProSe temporary identifier are/is revoked.

By means of the technical solution of the embodiment of the present disclosure, the monitoring UE is notified of a new ProSe temporary identifier and/or is notified that the ProSe temporary identifier is revoked, such that the monitoring UE can learn of the fact that the ProSe temporary identifier of the announcing UE is revoked, and thus a UE discovery fault is avoided.

In one implementation of the embodiment of the present disclosure, the method may further include the steps as follows. Anew ProSe temporary identifier of the announcing UE is acquired. A monitoring UE having acquired the ProSe temporary identifier is notified of the new ProSe temporary identifier and/or a mask and/or filter of the new ProSe temporary identifier.

In the embodiment of the present disclosure, the new ProSe temporary identifier may be sent. A mask or a filter may be sent, and the mask or the filter may correspond to an old ProSe temporary identifier or a new ProSe temporary identifier, such that the monitoring UE can be matched to one or more temporary identifiers.

In one implementation of the embodiment of the present disclosure, the new ProSe temporary identifier or the revoked ProSe temporary identifier may be acquired from a ProSe function to which the announcing UE corresponds. A method for acquiring, by the ProSe function to which the announcing UE corresponds, the above information may refer to the description of the above embodiment of the present disclosure, which will not be elaborated herein.

In one implementation of the embodiment of the present disclosure, the method may further include the steps as follows. A reason for revoking the ProSe temporary identifier acquired by the announcing UE is acquired. The monitoring UE is notified of the reason. In the embodiment of the present disclosure, the reason may be acquired in Step S702, or may be acquired by means of an independent step/message. Preferably, the reason is acquired in Step S702 simultaneously. Furthermore, the sender may send contents in Step S702 and the above reason simultaneously.

According to an embodiment of the present disclosure, in correspondence to the above method, an apparatus for notifying a ProSe temporary identifier is also provided. It is conceivable that the apparatus may be implemented by means of a program unit, and the program unit may be located in a memory of a device and executed by a processor of the device. The device may be a device where a ProSe function, to which a monitoring UE corresponds, is located. Certainly, other devices which can be conceived by those skilled in the art are also applicable.

FIG. 8 is a structural diagram 2 of an apparatus for notifying a ProSe temporary identifier according to an embodiment of the present disclosure. As shown in FIG. 8, the apparatus includes: an acquisition component 802 and a notification component 804, wherein the acquisition component 802 is configured to acquire that a ProSe temporary identifier acquired by an announcing UE is revoked; and the notification component 804 is configured to notify a monitoring UE having acquired the revoked ProSe temporary identifier that the ProSe temporary identifier is revoked and/or a mask and/or filter of the ProSe temporary identifier is revoked.

By means of the technical solution of the embodiment of the present disclosure, the monitoring UE is notified of a new ProSe temporary identifier and/or the monitoring UE is notified that the ProSe temporary identifier is revoked, such that the monitoring UE can learn of the fact that the ProSe temporary identifier of the announcing UE is revoked, and a UE discovery fault is avoided.

In one implementation of the embodiment of the present disclosure, the acquisition component 802 is further configured to acquire a new ProSe temporary identifier of the announcing UE; and the notification component 804 is further configured to notify the monitoring UE having acquired the ProSe temporary identifier of the new ProSe temporary identifier and/or a mask and/or filter of the new ProSe temporary identifier.

In one implementation of the embodiment of the present disclosure, the new ProSe temporary identifier or the revoked ProSe temporary identifier may be acquired, by the acquisition component 802, from a ProSe function to which the announcing UE corresponds. A method for acquiring, by the ProSe function to which the announcing UE corresponds, the above information may refer to the description of the above embodiment of the present disclosure, which will not be elaborated herein.

In one implementation of the embodiment of the present disclosure, the acquisition component 802 may be further configured to acquire a reason for revoking the ProSe temporary identifier acquired by the announcing UE. The notification component 804 may be further configured to notify the monitoring UE of the reason. In the embodiment of the present disclosure, the reason may be acquired in Step S702, or may be acquired by means of an independent step/message. Preferably, the reason is acquired in Step S702 simultaneously. Furthermore, the sender may send contents in Step S702 and the above reason simultaneously.

According to an embodiment of the present disclosure, a method for notifying a ProSe temporary identifier is also provided. The method may be executed by an HSS. Certainly, situations that the method is executed by other devices or functions which can be conceived by those skilled in the art are also applicable. Those skilled in the art may set corresponding communication interfaces to acquire needed information as required so as to conveniently execute the above method.

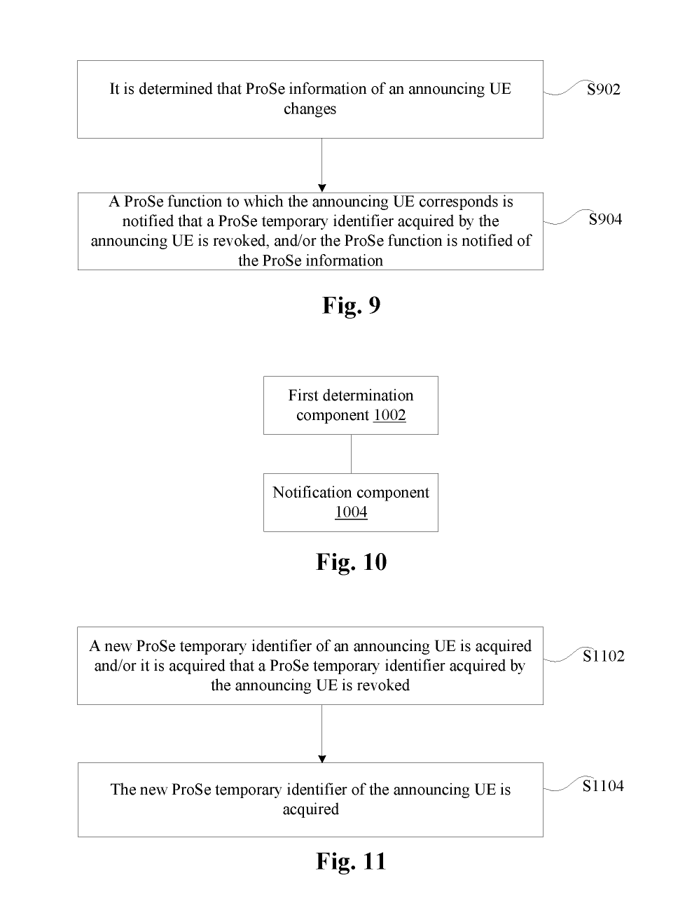

FIG. 9 is a flowchart 3 of a method for notifying a ProSe temporary identifier according to an embodiment of the present disclosure. As shown in FIG. 9, the method includes Step S902 to Step S904.

Step S902: It is determined that ProSe information of an announcing UE changes.

Step S904: A ProSe function to which the announcing UE corresponds is notified that a ProSe temporary identifier acquired by the announcing UE is revoked, and/or the ProSe function is notified of the ProSe information.

By means of the technical solution of the embodiment of the present disclosure, the ProSe function to which the announcing UE corresponds is notified of ProSe change information or the ProSe function is notified that the ProSe temporary identifier is revoked, such that the ProSe function to which the announcing UE corresponds can perceive or judge whether or not the ProSe temporary identifier is revoked, thus avoiding a UE discovery fault.

In one implementation of the embodiment of the present disclosure, the method may further include the steps as follows. An MME where the announcing UE resides is notified of the ProSe information. The MME judges, according to the ProSe information, whether or not to reclaim announcing resources allocated for the announcing UE.

In one implementation of the embodiment of the present disclosure, before the ProSe function is notified that the ProSe temporary identifier acquired by the announcing UE is revoked, it may be determined, according to the ProSe information, that the ProSe temporary identifier is revoked. Certainly, in the case of only notifying of the ProSe information, the above judgment may not be performed.

The ProSe information includes at least one of: ProSe subscription change information and register state change information. The ProSe subscription change information may include: change of the announcing UE from ProSe supportive UE to ProSe non-supportive UE, or from discovery allowing UE to discovery disallowing UE. The register state change information may include: movement of the announcing UE to another PLMN, or receiving of a purge process initiated by an MME of a PLMN to which the announcing UE is currently registered.

According to an embodiment of the present disclosure, in correspondence to the above method, an apparatus for notifying a ProSe temporary identifier is also provided. The apparatus may be located in an HSS. Certainly, situations that the apparatus is executed by other devices or functions which can be conceived by those skilled in the art are also applicable. It is conceivable that the apparatus may be implemented by means of a program unit, and the program unit may be located in a memory of a device and executed by a processor of the device.

FIG. 10 is a structural diagram 3 of an apparatus for notifying a ProSe temporary identifier according to an embodiment of the present disclosure. As shown in FIG. 10, the apparatus may include: a first determination component 1002 and a notification component 1004, wherein the first determination component 1002 is configured to determine that ProSe information of an announcing UE changes. The notification component 1004 is configured to notify a ProSe function, to which the announcing UE corresponds, that a ProSe temporary identifier acquired by the announcing UE is revoked, and/or notify the ProSe function of the ProSe information.

By means of the technical solution of the embodiment of the present disclosure, the notification component 1004 notifies the ProSe function, to which the announcing UE corresponds, of ProSe change information or notifies the ProSe function that the ProSe temporary identifier is revoked, such that the ProSe function to which the announcing UE corresponds can perceive or judge whether or not the ProSe temporary identifier is revoked, thus avoiding a UE discovery fault.

In one exemplary implementation of the embodiment of the present disclosure, the notification component 1004 is further configured to notify an MME, where the announcing UE resides, of the ProSe information. The MME judges, according to the ProSe information, whether or not to reclaim announcing resources allocated for the announcing UE.

In one exemplary implementation of the embodiment of the present disclosure, the apparatus may further include: a second determination component, configured to determine, according to the ProSe information, that the ProSe temporary identifier is revoked before the ProSe function is notified that the ProSe temporary identifier is revoked.

The ProSe information includes at least one of: ProSe subscription change information and register state change information. The ProSe subscription change information may include: change of the announcing UE from ProSe supportive UE to ProSe non-supportive UE, or from discovery allowing UE to discovery disallowing UE. The register state change information may include: movement of the announcing UE to another PLMN, or receiving of a purge process initiated by an MME of a PLMN to which the announcing UE is currently registered.

According to an embodiment of the present disclosure, a method for updating a ProSe temporary identifier is also provided.

FIG. 11 is a flowchart of a method for updating a ProSe temporary identifier according to an embodiment of the present disclosure. As shown in FIG. 11, the method includes Step S1102 to Step S1104.

Step S1102: A new ProSe temporary identifier of an announcing UE is acquired and/or it is acquired that a ProSe temporary identifier acquired by the announcing UE is revoked.

In one exemplary implementation of the embodiment of the present disclosure, when it is acquired in Step S1102 that the acquired ProSe temporary identifier is revoked, the method may further include Step S1104.

Step S1104: The new ProSe temporary identifier of the announcing UE is acquired. By means of the technical solution of the embodiment of the present disclosure, the announcing UE or a monitoring UE can judge whether or not the ProSe temporary identifier is revoked, thus avoiding a UE discovery fault.

In one implementation of the embodiment of the present disclosure, upon acquiring that the ProSe temporary identifier is revoked, the monitoring UE may send a monitor request used for re-acquiring a ProSe temporary identifier, and then receive the new ProSe temporary identifier, returned in response to the monitor request, of the announcing UE.

In one implementation of the embodiment of the present disclosure, a mask and/or filter of the new ProSe temporary identifier and/or the fact that a mask and/or filter of the ProSe temporary identifier acquired by the announcing UE are/is revoked may also be acquired. The monitoring UE can be matched to one or more ProSe temporary identifiers according to the mask and/or the filter.

The acquisition of the mask and/or the filter may be completed in Step S1102 or in an independent step. Preferably, the acquisition is completed in Step S1102.

The monitoring UE may acquire the above information from the ProSe function to which the monitoring UE corresponds. A method for acquiring, by the ProSe function to which the monitoring UE corresponds, the above information may refer to the above embodiment of the present disclosure, which will not be elaborated herein.

In one implementation of the embodiment of the present disclosure, upon acquiring that the ProSe temporary identifier is revoked, the announcing UE may send a discovery request used for re-acquiring a ProSe temporary identifier, and then receive the new ProSe temporary identifier, returned in response to the discovery request, of the announcing UE.

The announcing UE may acquire the above information from the ProSe function to which the announcing UE corresponds. A method for acquiring, by the ProSe function to which the announcing UE corresponds, the above information may refer to the above embodiment of the present disclosure, which will not be elaborated herein.

In one implementation of the embodiment of the present disclosure, a reason for revoking the ProSe temporary identifier acquired by the announcing UE may also be acquired. The reason may include, but are not limited to, ProSe function management and maintenance, application layer notice indicating that a UE identifier of the announcing UE is revoked, ProSe subscription change information and/or register state change information.

According to an embodiment of the present disclosure, in correspondence to the above method, an apparatus for updating a ProSe temporary identifier is also provided. The apparatus may be located in a monitoring UE or an announcing UE. It is conceivable that the apparatus may be implemented by means of a computer program, the monitoring UE or the announcing UE may include a processor and a storage medium, and the program unit may be stored in the storage medium and executed by the processor.

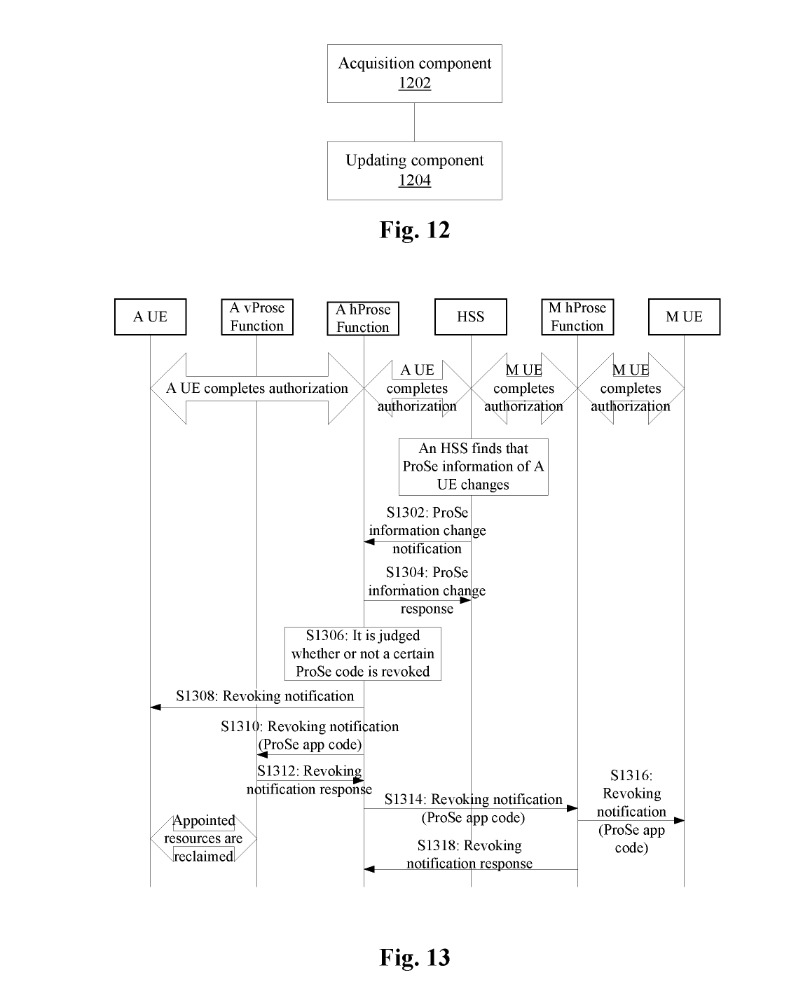

FIG. 12 is a structural diagram of an apparatus for updating a ProSe temporary identifier according to an embodiment of the present disclosure. As shown in FIG. 12, the apparatus includes: an acquisition component 1202, configured to acquire a new ProSe temporary identifier of an announcing UE and/or acquire that a ProSe temporary identifier acquired by the announcing UE is revoked.

In one implementation of the embodiment of the present disclosure, if it is acquired that the ProSe temporary identifier is revoked, the apparatus may further include: an updating component 1204, configured to acquire the new ProSe temporary identifier of the announcing UE.

By means of the technical solution of the embodiment of the present disclosure, the announcing UE or a monitoring UE can judge whether or not the ProSe temporary identifier is revoked, thus avoiding a UE discovery fault.

In one implementation of the embodiment of the present disclosure, the updating component 1204 (first updating component) may include: a first request unit, configured to initiate, when it is acquired that the ProSe temporary identifier is revoked, a monitor request used for re-acquiring a ProSe temporary identifier; and a first receiving unit, configured to receive the new ProSe temporary identifier, returned in response to the monitor request, of the announcing UE.

In one implementation of the embodiment of the present disclosure, the acquisition component 1202 may be further configured to acquire that a mask and/or filter of the ProSe temporary identifier acquired by the announcing UE are/is revoked and/or acquire a mask and/or filter of the new ProSe temporary identifier. The monitoring UE can be matched to one or more ProSe temporary identifiers according to the mask and/or the filter.

The acquisition of the mask and/or the filter may be completed in Step S1102 or in an independent step. Preferably, the acquisition is completed in Step S1102. That is, when acquiring the new ProSe temporary identifier of the announcing UE and/or acquiring that the ProSe temporary identifier acquired by the announcing UE is revoked, the acquisition component 1202 acquires the corresponding mask and/or filter.

In one implementation of the embodiment of the present disclosure, the updating component 1204 (second updating component) may include: a second request unit, configured to initiate, when it is acquired that the ProSe temporary identifier is revoked, a discovery request used for re-acquiring a ProSe temporary identifier; and a second receiving unit, configured to receive the new ProSe temporary identifier, returned in response to the discovery request, of the announcing UE.

According to an embodiment of the present disclosure, a device for ProSe is also provided, which includes: any apparatus for notifying a ProSe temporary identifier in the embodiments of the present disclosure.

It is conceivable that any apparatus for notifying a ProSe temporary identifier can be implemented by means of a program unit. The device for ProSe in the embodiment of the present disclosure may include a processor and a storage medium. The computer program unit implementing the above apparatus may be stored in the storage medium and executed by the processor.

According to an embodiment of the present disclosure, a terminal for ProSe is also provided, which includes: any apparatus for updating a ProSe temporary identifier in the embodiments of the present disclosure.

It is conceivable that any apparatus for updating a ProSe temporary identifier can be implemented by means of a program unit. The terminal for ProSe in the embodiment of the present disclosure may include a processor and a storage medium. The computer program unit implementing the above apparatus may be stored in the storage medium and executed by the processor.

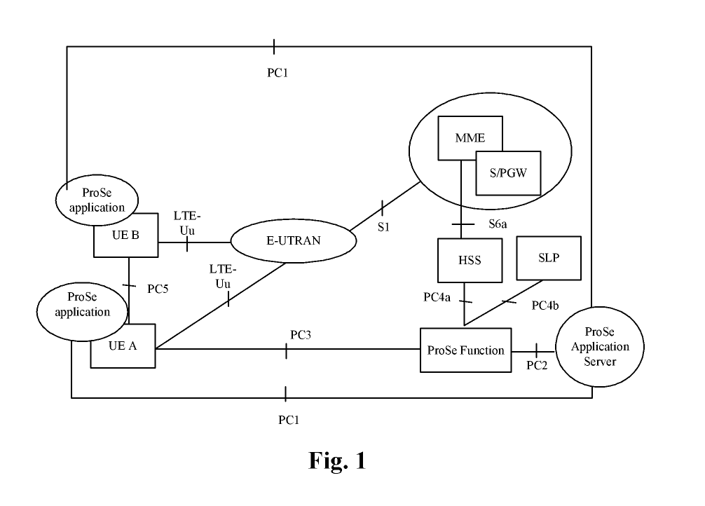

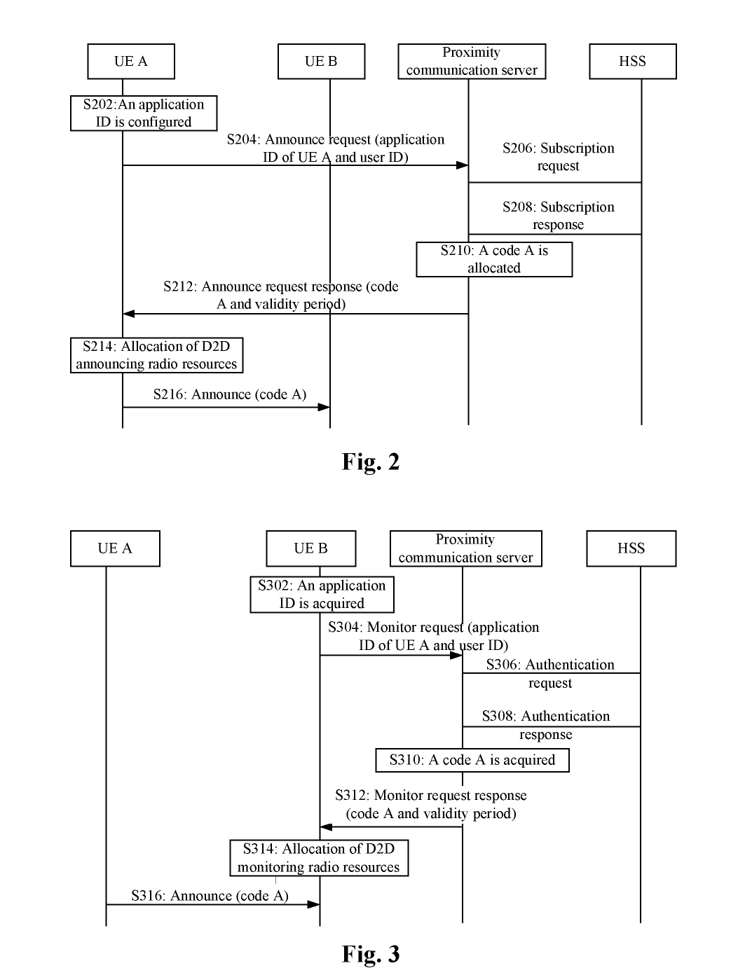

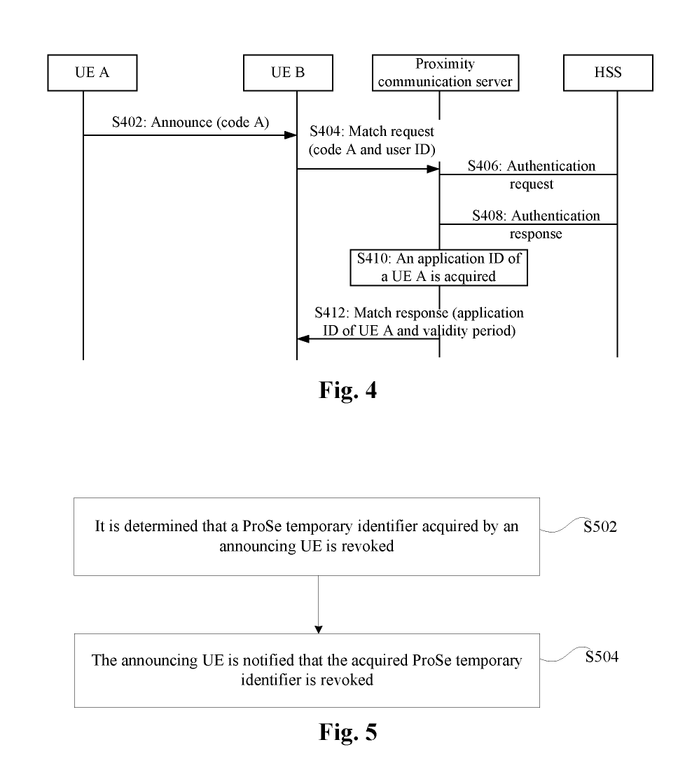

Exemplary embodiments in the embodiments of the present disclosure are described below. In the following exemplary embodiments, a network structure refers to a system in FIG. 1.

Exemplary Implementation 1

In the exemplary implementation, an HSS triggers update of a ProSe identifier. Before the flow is implemented, it is supposed that an announcing UE and a monitoring UE have been authorized by respective networks and have acquired temporary identifiers or identifier filters of specific users. The ProSe identifier update triggered by the HSS is mainly applied to the occasions where ProSe subscription data changes or the HSS finds that a register state of a User Equipment (UE) changes. For example, the UE moves to another PLMN or receives a purge process initiated by an MME of a PLMN to which the announcing UE is currently registered. These processes may probably cause unavailability of the UE in a current network. However, the judgement may be executed by the HSS or a home ProSe function.

FIG. 13 is a flowchart of a method for updating a ProSe temporary identifier according to an exemplary implementation 1 of an embodiment of the present disclosure. As shown in FIG. 13, the method includes Step S1302 to Step S1318.

Step S1302 to Step S1304: An HSS detects that a ProSe function of a UE A changes.

The ProSe function change of the UE A may include, but is not limited to, ProSe subscription change (for example, change from discovery allowing to discovery disallowing, and change from ProSe function supporting to ProSe function non-supporting). Or, the HSS finds that a register state of the UE changes. For example, the UE moves to another PLMN or receives a purge process initiated by an MME of a PLMN to which the announcing UE is currently registered.

In Step S1302 to Step S1304, the HSS may judge whether or not a current temporary identifier is revoked. If the current temporary identifier is revoked, a ProSe function is directly notified of the fact that the user identifier is revoked. Or, to reduce the load of the HSS and the logic complexity, the HSS only needs to notify the ProSe function of relevant ProSe information, and the ProSe function judges whether or not the current temporary identifier is revoked. After receiving the information, the ProSe function returns a ProSe information change notification to the HSS.

Step S1306: After receiving the information, the ProSe function judges whether or not a temporary identifier (ProSe temporary identifier, e.g., ProSe Application Code) of a user is revoked. Optionally, the ProSe function may also determine a specific reason value for revoking the temporary identifier.

In the above scenario, if the UE switches to another PLMN, the identifier may still be valid. However, since it is necessary to re-perform authorization in a new VPLMN and the previously registered VPLMN cannot allocate resources for the announcing UE, it is also necessary to send a notification similar to revoking notification in this case, so that the UE re-initiates an announce request.

Step S1308: The ProSe function notifies the UE that the previously allocated temporary identifier is revoked. Optionally, the notification may further include a specific reason value for revoking the temporary identifier.

After receiving the notification, the UE needs to initiate an announce request to the ProSe function immediately so as to implement authorization again.

Step S1310 to S1312: The ProSe function notifies a ProSe function of a visited network, on which the UE registers previously, that the previously allocated temporary identifier is revoked, wherein a true ProSe identifier or the previous temporary identifier is carried, wherein the previous temporary identifier is carried to enable the UE to learn which ProSe application is revoked. Optionally, the notification may further include a specific reason value for revoking the temporary identifier.

A visited ProSe function finds a context of the UE according to the true ProSe identifier and the previously allocated temporary identifier. If the visited ProSe function and a wireless node have interfaces there between, the visited ProSe function notifies the wireless node to reclaim announcing resources allocated for the UE. The visited ProSe function sends a revoking response to the home ProSe function. After receiving the message, the visited ProSe function may end charging.

Step S1314: A home ProSe function of an announcing UE sends a revoking notification to a home ProSe function to which a UE (namely a monitoring UE), that has ever inquired for the announcing UE, corresponds. The home ProSe function of the announcing UE may save an identifier of the monitoring UE in a previous request process, and send a revoking notification to the ProSe function to which the monitoring UE corresponds. The ProSe function may send a message to each recorded monitoring UE as required or send a message to the ProSe function, the message carrying an identity list of all monitoring UEs in the PLMN. The revoking notification carries the true ProSe identifier, or the previously allocated temporary identifier, or a mask or a filer generated according to the temporary identifier, which is used for matching which ProSe application is revoked. Optionally, the revoking notification may further include a specific reason value for revoking the temporary identifier.

Step S1316: The ProSe function notifies the UE that the previously allocated temporary identifier of the announcing UE is revoked or the filter or mask generated according to the temporary identifier is revoked. After receiving the notification, the UE initiates a monitor request to the ProSe function, thus acquiring an updated ProSe temporary identifier of the announcing UE. Optionally, the notification may further include a specific reason value for revoking the temporary identifier.

Step S1318: The home ProSe function of the monitoring UE returns a revoking notification response to the home ProSe function of the announcing UE.

The sequence for executing Step S1316 and Step S1318 is not limited.

The ProSe function of the announcing UE may select to notify the ProSe function after the announcing UE completes re-allocation of the temporary identifier. In this case, in Step S1314, an identifier of the announcing UE and a recently allocated temporary identifier are carried. In this case, in Step S1316, the monitoring UE may be directly notified to acquire a latest code from the home ProSe function of the monitoring UE.

Exemplary Implementation 2

In the exemplary implementation, a ProSe function triggers update of a ProSe identifier. Before the flow is implemented, it is supposed that an announcing UE and a monitoring UE have been authorized by respective networks and have acquired temporary identifiers or identifier filters of specific users. The ProSe identifier update triggered by the HSS is mainly applied to function change of the ProSe function itself such as background management of an operator, number section reclaim and application layer notification.

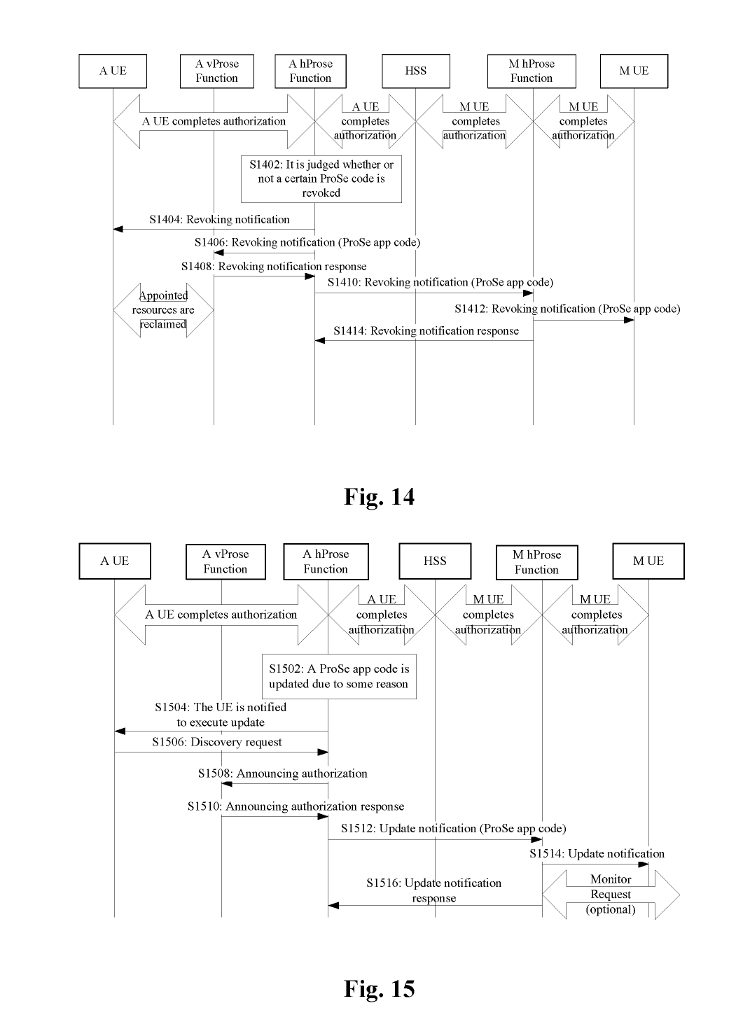

FIG. 14 is a flowchart of a method for updating a ProSe temporary identifier according to an exemplary implementation 2 of an embodiment of the present disclosure. As shown in FIG. 14, the method includes Step S1402 to Step S1414.

Step S1402: a temporary identifier allocated for a UE is revoked due to function change of a ProSe function.

Step S1404: The ProSe function notifies a UE that the previously allocated temporary identifier is revoked. Optionally, the notification may further include a specific reason value for revoking the temporary identifier. After receiving the notification, the UE needs to initiate an announce request to the ProSe function immediately so as to implement authorization again.

Step S1406 to S1408: The ProSe function notifies a ProSe function of a visited network, on which the UE registers previously, that the previously allocated temporary identifier is revoked, wherein a true ProSe identifier or the previous temporary identifier is carried, wherein the previous temporary identifier is carried to enable the UE to learn which ProSe application is revoked. A visited ProSe function finds a context of the UE according to the true ProSe identifier and the previously allocated temporary identifier, and reclaims announcing resources allocated for the UE. The visited ProSe function sends a revoking response to a home ProSe function. After receiving the message, the visited ProSe function may end charging. Optionally, the notification may further include a specific reason value for revoking the temporary identifier.

Step S1410: A home ProSe function of an announcing UE sends a revoking notification to a home ProSe function to which a UE (namely a monitoring UE), that has ever inquired for the announcing UE, corresponds. The home ProSe function of the announcing UE may save an identifier of the monitoring UE in a previous request process, and send a revoking notification to the ProSe function to which the monitoring UE corresponds. The ProSe function may send a message to each recorded monitoring UE as required or send a message to the ProSe function, the message carrying an identity list of all monitoring UEs in the PLMN. The revoking notification carries the true ProSe identifier, or the previously allocated temporary identifier, or a mask or a filer generated according to the temporary identifier, which is used for matching which ProSe application is revoked. Optionally, the revoking notification may further include a specific reason value for revoking the temporary identifier.

Step S1412: The ProSe function notifies the UE that the previously allocated temporary identifier of the announcing UE is revoked or the filter or mask generated according to the temporary identifier is revoked. After receiving the notification, the UE initiates a monitor request to the ProSe function, thus acquiring an updated ProSe temporary identifier of the announcing UE. Optionally, the notification may further include a specific reason value for revoking the temporary identifier.

Step S1414: The home ProSe function of the monitoring UE returns a revoking notification response to the home ProSe function of the announcing UE. The sequence for executing Step S1410 and Step S1412 is not limited.

The ProSe function of the announcing UE may select to notify the ProSe function after the announcing UE completes re-allocation of the temporary identifier. In this case, in Step S1410, an identifier of the announcing UE and a recently allocated temporary identifier are carried. In this case, in Step S1412, the monitoring UE may be directly notified to acquire a latest code from the home ProSe function of the monitoring UE.

Exemplary Implementation 3

In the exemplary implementation, a ProSe function triggers update of a ProSe identifier. Before the flow is implemented, it is supposed that an announcing UE and a monitoring UE have been authorized by respective networks and have acquired temporary identifiers or identifier filters of specific users. The ProSe identifier update triggered by the HSS is mainly applied to function change of the ProSe function itself such as background management of an operator and configuration change.

FIG. 15 is a flowchart of a method for updating a ProSe temporary identifier according to an exemplary implementation 3 of an embodiment of the present disclosure. As shown in FIG. 15, the method includes Step S1502 to Step S1516.

Step S1502: A temporary identifier allocated for a UE is revoked due to function change of a ProSe function.

Step S1504: The ProSe function notifies a UE that the previously allocated temporary identifier is revoked. Optionally, the notification may further include a specific reason value for revoking the temporary identifier. After receiving the notification, the UE needs to initiate an announce request to the ProSe function immediately so as to implement authorization again.

If the notification message in this case is sent based on safety connection, a new temporary identifier may be carried in Step S1504. The UE may not re-initiate a discovery request to acquire the identifier. If this mode is adopted, a visited network of the UE may be notified immediately. Otherwise, the visited network will be notified after Step S1506.

Step S1506: The UE carries the discovery request, carrying a true ProSe identifier of the UE.

Step S1508 to S1510: The ProSe function notifies, by means of announcing authorization, a ProSe function of the visited network, on which the UE registers previously, that the previously allocated temporary identifier is revoked, and notifies that the previously allocated temporary identifier has been replaced with a new temporary identifier, wherein a true ProSe identifier or the previous temporary identifier is carried, wherein the previous temporary identifier is carried to enable the UE to learn which ProSe application is revoked. A visited ProSe function finds a context of the UE according to the true ProSe identifier or the previously allocated temporary identifier. The message may further include the new temporary identifier allocated for the UE. The visitor location receives and saves the new temporary identifier. The visited ProSe function sends an announcing authorization response to a home ProSe function. Optionally, the notification may further include a specific reason value for revoking the temporary identifier.

Step S1512: A home ProSe function of an announcing UE sends a revoking notification to the home ProSe function to which a UE (namely a monitoring UE), that has ever inquired for the announcing UE, corresponds. The home ProSe function of the announcing UE may save an identifier of the monitoring UE in a previous request process, and send an update notification to the ProSe function to which the monitoring UE corresponds. The ProSe function may send a message to each recorded monitoring UE as required or send a message to the ProSe function, the message carrying an identity list of all monitoring UEs in the PLMN. The message carries the new temporary identifier allocated for the announcing UE. The update notification carries the true ProSe identifier, or the previously allocated temporary identifier, or a mask or a filer generated according to the temporary identifier, which is used for matching which ProSe application is revoked. Optionally, the notification may further include a specific reason value for revoking the temporary identifier.

Step S1514: The ProSe function notifies the UE that the previously allocated temporary identifier of the announcing UE is revoked or the filter or mask generated according to the temporary identifier is revoked. After receiving the notification, the UE initiates a monitor request to the ProSe function, thus acquiring an updated ProSe temporary identifier of the announcing UE. Optionally, the notification may further include a specific reason value for revoking the temporary identifier.

If the notification in this case is based on safety connection, a new temporary identifier may be carried in Step S1514. The UE may not re-initiate a discovery request to acquire the identifier. Otherwise, the UE needs to initiate a discovery request to acquire a new identifier of the announcing UE.

Step S1516: The home ProSe function of the monitoring UE returns an update notification response to the home ProSe function of the announcing UE. The message may be executed immediately after the UE is notified, or executed after the UE initiates the discovery request. Therefore, optionally, the message may carry an indicator indicating whether or not the identifier is updated.

The ProSe function of the announcing UE may select to notify the ProSe function after the announcing UE completes re-allocation of the temporary identifier. In this case, in Step S1504, an identifier of the announcing UE and a recently allocated temporary identifier are carried. In this case, in Step S1514, the monitoring UE may be directly notified to acquire a latest code from the home ProSe function of the monitoring UE.

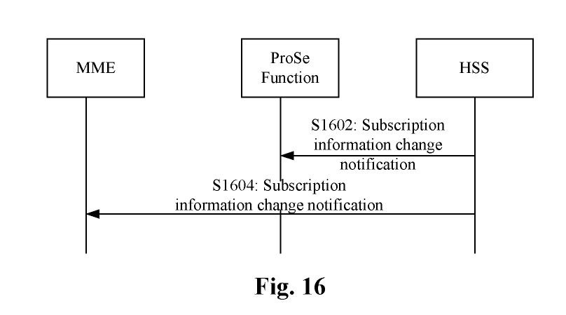

FIG. 16 is a flowchart of showing a scenario where an HSS initiates subscription data modification according to an embodiment of the present disclosure. As shown in FIG. 16, the method includes Step S1602 to Step S1604.

Step S1602: If detecting that ProSe subscription data of a user changes, an HSS sends a subscription data change notification to a ProSe Function where the user resides currently. After receiving the notification, the ProSe Function will check the changing data, and if a UE is no longer allowed to use ProSe, the steps shown in the exemplary implementation 1 are carried out. The ProSe Function returns a notification response to the HSS.

Step S1604: If detecting that the ProSe subscription data of the user changes, the HSS sends a subscription data change notification to an MME where the user resides currently. After receiving the notification, the MME will check the changing data, and if the UE is no longer allowed to use the ProSe, a base station is notified of cancellation of authorization for the ProSe. The MME returns a notification response to the HSS.

In the exemplary implementation, Step S1602 and S1604 may occur simultaneously.

From the above description, it may be seen that the present disclosure achieves the technical effect as follows. The problem that an announcing UE cannot learn of the fact that a ProSe temporary identifier is revoked is solved, and a UE discovery fault is avoided.

Obviously, those skilled in the art shall understand that all components or all steps in the present disclosure may be implemented using a general calculation apparatus, may be centralized on a single calculation apparatus or may be distributed on a network composed of a plurality of calculation apparatuses. Optionally, they may be implemented using executable program codes of the calculation apparatuses. Thus, they may be stored in a storage apparatus and executed by the calculation apparatuses, the shown or described steps may be executed in a sequence different from this sequence under certain conditions, or they are manufactured into each integrated circuit component respectively, or a plurality of components or steps therein is manufactured into a single integrated circuit component. Thus, the present disclosure is not limited to combination of any specific hardware and software.

The above is only the exemplary embodiments of the present disclosure, and is not intended to limit the present disclosure. There may be various modifications and variations in the present disclosure for those skilled in the art. Any modifications, equivalent replacements, improvements and the like within the principle of the present disclosure shall fall within the protective scope defined by the appended claims of the present disclosure.

### INDUSTRIAL APPLICABILITY

As above, methods and apparatuses for notifying or updating a ProSe temporary identifier provided by the embodiments of the present disclosure have the beneficial effects as follows. The problem that an announcing UE cannot learn of the fact that a ProSe temporary identifier is revoked is solved, and the effect of avoiding a UE discovery fault is achieved.

1. A method for notifying a Proximity-based Services (ProSe) temporary identifier, comprising:
determining that a first ProSe temporary identifier acquired by an announcing User Equipment (UE) is revoked; and
notifying the announcing UE that the first ProSe temporary identifier is revoked.

2. The method as claimed in claim 1, further comprising:
notifying the announcing UE of a new second ProSe temporary identifier of the announcing UE.

3. The method as claimed in claim 1, further comprising:
notifying a ProSe function, to which a monitoring UE having acquired the first ProSe temporary identifier corresponds, that the first ProSe temporary identifier is revoked and/or a filter and/or mask of the first ProSe temporary identifier is revoked, and/or notifying the ProSe function of a second ProSe temporary identifier and/or a filter and/or mask of the second ProSe temporary identifier.

4. The method as claimed in claim 1, further comprising:
notifying a visited ProSe function of the announcing UE of a second ProSe temporary identifier and/or notifying the visited ProSe function that the first ProSe temporary identifier is revoked.

5. (canceled)

6. The method as claimed in claim 1, wherein determining that the first ProSe temporary identifier acquired by the announcing UE is revoked comprises at least one of:
determining, upon receiving from a Home Subscriber Server (HSS) a message used for notifying that the first ProSe temporary identifier is revoked, that the first ProSe temporary identifier is revoked;
determining, upon receiving from the HSS a message used for notifying ProSe information of the announcing UE, that the first ProSe temporary identifier is revoked according to the ProSe information; and
determining, according to a function change of a ProSe function, that the first ProSe temporary identifier is revoked.

7. The method as claimed in claim 6, wherein the ProSe information comprises at least one of: ProSe subscription change information and register state change information; and/or, the function change of the ProSe function comprises at least one of: ProSe function management and maintenance, and application layer notice indicating that a UE identifier of the announcing UE is revoked.

8. (canceled)

9. (canceled)

10. (canceled)

11. (canceled)

12. (canceled)

13. A method for notifying a Proximity-based Services (ProSe) temporary identifier, comprising:
acquiring that a first ProSe temporary identifier acquired by an announcing User Equipment (UE) is revoked; and
notifying a monitoring UE, which has acquired the first ProSe temporary identifier, that the first ProSe temporary identifier is revoked and/or a filter and/or mask of the first ProSe temporary identifier is revoked.

14. The method as claimed in claim 13, further comprising:
acquiring a new second ProSe temporary identifier of the announcing UE; and
notifying the monitoring UE, which has acquired the first ProSe temporary identifier, of a second ProSe temporary identifier and/or a filter and/or mask of the second ProSe temporary identifier.

15. (canceled)

16. A method for updating a Proximity-based Services (ProSe) temporary identifier, comprising:
acquiring a new second ProSe temporary identifier of an announcing User Equipment (UE) and/or acquiring that a first ProSe temporary identifier acquired by the announcing UE is revoked.

17. The method as claimed in claim 16, wherein when it is acquired that the first ProSe temporary identifier is revoked, the method further comprises:
initiating a monitor request used for re-acquiring a ProSe temporary identifier; and
receiving the second ProSe temporary identifier returned in response to the monitor request.

18. The method as claimed in claim 16, further comprising:
acquiring a filter and/or mask of the second ProSe temporary identifier and/or acquiring that a filter and/or mask of the first ProSe temporary identifier is revoked.

19. The method as claimed in claim 16, wherein when it is acquired that the first ProSe temporary identifier is revoked, the method further comprises:
initiating a discovery request used for re-acquiring a ProSe temporary identifier; and
receiving the second ProSe temporary identifier returned in response to the discovery request.

20. (canceled)

21. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 1.

22. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 2.

23. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 3.

24. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 4.

25. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 6.

26. (canceled)

27. (canceled)

28. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 13.

29. An apparatus for notifying a Proximity-based Services (ProSe) temporary identifier, comprising: a non-transitory computer-readable medium having program code recorded thereon, wherein the program code, when being executed by a processor, causes the processor to implement the method as claimed in claim 14.

30. An apparatus for updating a Proximity-based Services (ProSe) temporary identifier, comprising: a non-transitory computer-readable medium having program code recorded thereon, wherein the program code, when being executed by a processor, causes the processor to implement the method as claimed in claim 16.

31. An apparatus for updating a Proximity-based Services (ProSe) temporary identifier, comprising: a non-transitory computer-readable medium having program code recorded thereon, wherein the program code, when being executed by a processor, causes the processor to implement the method as claimed in claim 17.

32. An apparatus for updating a Proximity-based Services (ProSe) temporary identifier, comprising: a non-transitory computer-readable medium having program code recorded thereon, wherein the program code, when being executed by a processor, causes the processor to implement the method as claimed in claim 19.
